(19) United States
(12) Patent Application Publication
(10) Pub. No.: US 2007/0292809 A1
(43) Pub. Date: Dec. 20, 2007

(54) Process for the Production of Double-Layer Heat-Sensitive Imageable Elements

(75) Inventors: Celin Savariar-Hauck, Badenhausen (DE); Gerhard Hauck, Badenhausen (DE); Dietmar Frank, Northeim (DE)

Correspondence Address: EASTMAN KODAK COMPANY;PATENT LEGAL STAFF, 343 STATE STREET, ROCHESTER, NY, 14650-2201, US

(73) Assignee: KODAK POLYCHROME GRAPHICS, GMBH, 37520 OSTEROD (DE)

(21) Appl. No.: 10/574,870

(22) PCT Filed: Oct. 11, 2004
(86) PCT No.: PCT/EP04/11379

§ 371 Date: Apr. 6, 2006

(30) Foreign Application Priority Data
Oct. 14, 2003 (DE) 103 47 682.2

(51) Int. Cl. B41C 1/10; B41M 5/36

(52) U.S. Cl. 430/495.1; 427/385.5; 427/388.4

(57) ABSTRACT

The invention relates to a process for the production of a heat-sensitive imageable element comprising: (a) providing a substrate, (b) applying a first coating solution, comprising at least one photothermal conversion material, at least one polymer A soluble or swellable in an aqueous alkaline developer and at least one solvent, (c) drying, (d) applying a second coating solution, comprising at least one cross-linkable polyfunctional enolether, at least one polymer B comprising hydroxy groups and/or carboxy groups, and at least one solvent, wherein the polymer used in the first coating solution does not dissolve in this solvent, wherein the second coating solution does not contain a photothermal conversion material, and (e) drying at a temperature of at least 60° C.

The present invention relates to a process for the production of heat-sensitive positive working elements, in particular heat-sensitive printing plate precursors comprising two layers on the substrate, wherein a composition containing a polyfunctional enolether is used for the production of the top layer. The invention furthermore relates to elements produced according to this process as well as precursors of such elements.

The technical field of lithographic printing is based on the immiscibility of oil and water, wherein the oily material or the printing ink is preferably accepted by the image area, and the water or fountain solution is preferably accepted by the non-image area. When an appropriately produced surface is moistened with water and a printing ink is applied, the background or non-image area accepts the water and repels the printing ink, while the image area accepts the printing ink and repels the water. The printing ink in the image area is then transferred to the surface of a material such as paper, fabric and the like, on which the image is to be formed. Generally, however, the printing ink is first transferred to an intermediate material, referred to as blanket, which then in turn transfers the printing ink onto the surface of the material on which the image is to be formed; this technique is referred to as offset lithography.

A frequently used type of lithographic printing plate precursor (in this context the term printing plate precursor refers to a coated printing plate prior to exposure and developing) comprises a photosensitive coating applied onto a substrate on aluminum basis. The coating can react to radiation such that the exposed portion becomes so soluble that it is removed during the developing process. Such a plate is referred to as positive working. On the other hand, a plate is referred to as negative working if the exposed portion of the coating is hardened by the radiation. In both cases, the remaining image area accepts printing ink, i.e. is oleophilic, and the non-image area (background) accepts water, i.e. is hydrophilic. The differentiation between image and non-image areas takes place during exposure.

In conventional plates, a film containing the information to be transferred is attached to the plate precursor under vacuum in order to guarantee good contact. The plate is then exposed by means of a radiation source, part of which is comprised of UV radiation. When a positive plate is used, the area on the film corresponding to the image on the plate is so opaque that the light does not attack the plate, while the area on the film corresponding to the non-image area is clear and allows light to permeate the coating, whose solubility increases. In the case of a negative plate, the opposite takes place: The area on the film corresponding to the image on the plate is clear, while the non-image area is opaque. The coating beneath the clear film area is hardened due to the incident light, while the area not affected by the light is removed during developing. The light-hardened surface of a negative working plate is therefore oleophilic and accepts printing ink, while the non-image area that used to be coated with the coating removed by the developer is desensitized and therefore hydrophilic.

For several decades, positive working commercial printing plate precursors have been characterized by the use of alkali-soluble phenolic resins and naphthoquinone diazide derivatives; imaging was carried out with UV radiation.

Recent developments in the field of lithographic printing plate precursors have led to radiation-sensitive compositions suitable for the production of printing form precursors which can be addressed directly by lasers. The digital image-forming information can be used to convey an image onto a printing form precursor without the use of a film, as is common in conventional plates.

One example of a positive working, direct laser-addressable printing plate precursor is described in U.S. Pat. No. 4,708,925. The patent describes a lithographic printing plate precursor whose imaging layer comprises a phenolic resin and a radiation-sensitive onium salt. As described in the patent, the interaction between the phenolic resin and the onium salt results in an alkali of the composition, which restores the alkali solubility by photolytic decomposition of the onium salt. The printing form precursor can be used as a precursor of a positive working printing form or as a precursor of a negative printing form, if additional process steps are added between exposure and developing, as described in detail in British patent no. 2,082,339. The printing form precursors described in U.S. Pat. No. 4,708,925 are UV-sensitive per se and can additionally be sensitized to visible and IR radiation.

Another example of a direct laser-addressable printing form precursor that can be used as a positive working system is described in U.S. Pat. No. 5,372,907 and U.S. Pat. No. 5,491,046. These two patents describe the decomposition of a latent Bronsted acid by radiation in order to increase solubility of the resin matrix upon image-wise exposure. As in the case of the printing form precursor described in U.S. Pat. No. 4,708,925, these systems can also be used as negative working systems in combination with additional process steps between imaging and developing. In the case of the negative working printing plate precursors, the decomposition by-products are subsequently used to catalyze a crosslinking reaction between the resins in order to render the layer of the irradiated areas insoluble, which requires a heating step prior to developing. As in U.S. Pat. No. 4,708,925, these printing form precursors per se are UV-sensitive due to the acid-forming materials used.

U.S. Pat. No. 5,658,708 describes positive and negative working thermally imageable elements. In the case of the negative working elements, the coating, which is applied in one step, for example comprises a compound with at least two enolether groups and an alkali-soluble resin with acid groups capable of reacting with the enolether groups upon heating. Drying is carried out at a relatively low temperature. During the image-forming step, the coating is image-wise heated to a high temperature resulting in cross-linking which in turn renders the coating insoluble in the developer. In the case of positive working elements, the coating for example additionally comprises an acid former; drying is carried out at relatively high temperatures so that cross-linking of the coating of the unimaged element takes place, which coating is then insoluble in the developer. Inage-wise irradiation with IR radiation then renders the coating soluble in the developer. The use of acid formers has the disadvantage that it renders the plate sensitive to UV light and thus also daylight (also in the sense of normal room light).

The document DE 198 50 181 describes printing plate precursors whose radiation-sensitive layer comprises a polymeric binder, a compound that releases an acid when heated, a photothermal conversion material and a cross-linkable polyfunctional enolether, wherein the polymeric binder both comprises protective groups that can be cleaved off by acid or heat and functional groups that allow cross-linking with enolethers, and wherein the binder is insoluble in aqueous alkaline media with a pH≦13.5.

U.S. Pat. Nos. 6,358,669, 6,352,811, and 6,352,812 describe thermally imageable elements with a double-layer coating. However, these elements exhibit a certain sensitivity to scratching; furthermore, lithographic printing plates produced therefrom tend to abrade on the printing machine which in turn affects the number of prints that can be obtained.

A novolak is preferably used as polymeric component of the top layer of the printing plates described in U.S. Pat. No. 6,358,669 B1. The resistance of the imaged printing plate to organic solvents as well as the resistance to mechanical wear can be improved by subjecting the developed printing plate to a baking step (e.g. at 230° C.). However, the necessary baking step requires additional time and raises the production costs.

It is the object of the present invention to provide a process for the production of positive working thermally imageable elements, such as lithographic printing plate precursors, which leads to elements with increased scratch-resistance both in their unexposed (unimaged) state and their exposed but not yet developed state as well as in their developed state, so that higher numbers of prints can be obtained when they are used as printing plates. Furthermore, the elements thus obtained should be characterized by good developability and high sensitivity in combination with a high degree of developer resistance and resistance to chemicals.

It is furthermore an object of the present invention to provide imageable elements obtained by the above process, as well as precursors thereof.

The first object is surprisingly achieved by a process comprising

a) providing a substrate,

b) applying a first coating solution,

comprising at least one photothermal conversion material, at least one polymer A soluble or swellable in an aqueous alkaline developer and at least one solvent,
   c) drying,
   d) applying a second coating solution onto the dried first layer,
comprising at least one cross-linkable polyfunctional enolether, at least one polymer B comprising hydroxy groups and/or carboxy groups, and at least one solvent, wherein the polymer A used in the first coating solution does not dissolve in this solvent, wherein the second coating solution does not contain a photothermal conversion material, and
   e) drying at a temperature of at least 60° C.

The heat-sensitive elements obtained by the process of the present invention can for example be printing form precursors (in particular precursors of lithographic printing plates), printed circuit boards for integrated circuits or photomasks.

It is preferred that the substrate used in the process be stable at a temperature of at least 60° C., in particular 60 to 150° C., i.e. that it does not melt, shrink or decompose chemically.

A dimensionally stable plate or foil-shaped material is preferably used as a substrate in the production of printing plate precursors. Preferably, a material is used as dimensionally stable plate or foil-shaped material that has already been used as a substrate for printing forms. Examples of such substrates include paper, paper coated with plastic materials (such as polyethylene, polypropylene, polystyrene), a metal plate or foil, such as e.g. aluminum (including aluminum alloys), zinc and copper plates, plastic films made e.g. from cellulose diacetate, cellulose triacetate, cellulose propionate, cellulose acetate, cellulose acetatebutyrate, cellulose nitrate, polyethylene terephthalate, polyethylene, polystyrene, polypropylene, polycarbonate and polyvinyl acetate, and a laminated material made from paper or a plastic film and one of the above-mentioned metals, or a paper/plastic film that has been metallized by vapor deposition. Among these substrates, an aluminum plate or foil is especially preferred since it shows a remarkable degree of dimensional stability, is inexpensive and furthermore exhibits excellent adhesion to the coating. Furthermore, a composite film can be used wherein an aluminum foil has been laminated onto a polyethylene terephthalate film.

A metal substrate, in particular an aluminum substrate, is preferably subjected to a surface treatment, for example graining by brushing in a dry state or brushing with abrasive suspensions, or electrochemical graining, e.g. by means of a hydrochloric acid electrolyte, and optionally anodizing.

Furthermore, in order to improve the hydrophilic properties of the surface of the metal substrate that has been grained and optionally anodized in sulfuric acid or phosphoric acid, the metal substrate can be subjected to an aftertreatment with an aqueous solution of sodium silicate, calcium zirconium fluoride, polyvinylphosphonic acid or phosphoric acid. Within the framework of the present invention, the term “substrate” also encompasses an optionally pre-treated substrate exhibiting, for example, a hydrophilizing layer on its surface.

The details of the above-mentioned substrate pre-treatment are known to the person skilled in the art.

As used in the present invention, the term “(meth)acrylate” encompasses both “acrylate” and “methacrylate”; analogously, the same applies to the term “(meth)acrylic acid”.

For the purpose of the present invention, a polymer such as e.g. a novolak is considered soluble in an aqueous alkaline developer (with a pH of about 8 to 14) if 1 g or more dissolve in 100 ml of developer at room temperature.

The first layer comprises at least one polymer A soluble or swellable in an aqueous alkaline developer. In addition, this polymer should be insoluble in the solvent used for the second layer so that the top layer can be applied without dissolving the first layer. While novolaks are soluble in aqueous alkaline developers, they are not suitable as polymer A since they are soluble in the solvents suitable for the second layer; therefore, their use as polymer A is not encompassed by the present invention.

Examples include acrylic polymers and copolymers with carboxy functions, copolymers of vinyl acetate, crotonate and vinyl neodecanoate, copolymers of styrene and maleic acid anhydride, wood rosin esterified with maleic acid, and combinations thereof.

Particularly suitable polymers are derived from N-substituted maleimides, in particular N-phenylmaleimide, (meth)acrylamides, in particular methacrylamide, and acrylic acid and/or methacrylic acid, in particular methacrylic acid. Copolymers of two of these monomers are more preferred, and it is most preferred that all three monomers be contained in polymerized form. Preferred polymers of that type are copolymers of N-phenylmaleimide, (meth)acrylamide and (meth)acrylic acid, more preferred are those comprising 25 to 75 mole-% (more preferred 35 to 60 mole-%) N-phenylmaleimide, 10 to 50 mole-% (more preferred 15 to 40 mole-%) (meth)acrylamide and 5 to 30 mole-% (more preferred 10 to 30 mole-%) (meth)acrylic acid. Other hydrophilic monomers, such as hydroxyethyl(meth)acrylate, can be used instead of part of the (meth)acrylamide. Other monomers soluble in aqueous alkaline media can be used instead of (meth)acrylic acid.

Copolymers comprising a monomer in polymerized form which contains a urea group in its side chain form another group of preferred polymers A for the first coating solution; such copolymers are e.g. described in U.S. Pat. No. 5,731,127 B. These copolymers comprise 10 to 80 wt.-% (preferably 20 to 80 wt.-%) of at least one monomer of formula (I) below:
CH₂═CR—CO₂—X—NH—CO—NH—Y-Z (I)
wherein
R is a hydrogen atom or a methyl group,
X is a divalent spacer group,
Y is a divalent substituted or unsubstituted aromatic group, and
Z is selected from OH, COOH and SO₂NH₂.
R is preferably a methyl group.
X is preferably a substituted or unsubstituted alkylene group, a substituted or unsubstituted phenylene group (C₆H₄) or a substituted or unsubstituted naphthalene group (C₁₀H₆), such as —(CH₂)ₙ— (wherein n is an integer from 2 to 8), 1,2-, 1,3- and 1,4-phenylene and 1,4-, 2,7- and 1,8-naphthalene. More preferred, X is an unsubstituted alkylene group —(CH₂)ₙ— wherein n=2 or 3, and most preferred, X represents —(CH₂CH₂)—.
Y is preferably a substituted or unsubstituted phenylene group or substituted or unsubstituted naphthalene group. More preferred, Y is an unsubstituted 1,4-phenylene group.
Z is preferably OH.

A preferred monomer is
CH₂═C(CH₃)—CO₂—CH₂CH₂—NH—CO—NH-(p-C₆H₄)-Z (Ia)
wherein Z is selected from OH, COOH and SO₂NH₂, and is preferably OH.

Monomers comprising one or more urea groups can be used in the synthesis of the copolymers. In polymerized form, the copolymers furthermore comprise 20 to 90 wt.-% of other polymerizable monomers such as maleimide, acrylic acid, methacrylic acid, acrylic acid esters, methacrylic acid esters, acrylonitrile, methacrylonitrile, acrylamides and methacrylamides. Preferably, the copolymers soluble in alkaline solutions comprise 30 to 70 wt.-% of the monomer with urea group, 20 to 60 wt.-% acrylonitrile or methacrylonitrile (preferably acrylonitrile) and 5 to 25 wt.-% acrylamide or methacrylamide (preferably methacrylamide).

The polymers described above are soluble in aqueous alkaline developers; furthermore, they are soluble in polar solvents such as ethylene glycol monomethylether, which can be used as coating solvent for the first coating solution, or mixtures of methyl lactate, methanol and dioxolane. However, they are hardly soluble in less polar solvents such as acetone and 2-butanone, which can be used as solvents for the second coating solution without dissolving the first layer in the process. Both of the groups of polymers described above can be prepared by means of known processes of free-radical polymerization.

Derivatives of methylvinylether/maleic acid anhydride copolymers comprising an N-substituted cyclic imide unit and derivatives of styrene/maleic acid anhydride copolymers comprising an N-substituted cyclic imide unit can also be used as polymer A in the first coating solution if they are soluble in aqueous alkaline media. Such copolymers can for example be prepared by reacting maleic acid anhydride copolymer and an amine such as p-aminobenzene sulfonamide or p-aminophenol and subsequent cyclization by means of an acid.

Another group of polymers that can be used in the first coating solution are copolymers comprising 1 to 90 mole-% of a sulfonamide monomer unit, in particular N-(p-aminosulfonylphenyl)methacrylamide, N-(m-aminosulfonylphenol)methacrylamide, N-(o-aminosulfonylphenyl)methacrylamide and/or corresponding acrylamides. Suitable polymers comprising a sulfonamide group in their pendant-group, processes for their production as well as suitable monomers are described in U.S. Pat. No. 5,141,838 B. Especially suitable polymers comprise (1) a sulfonamide monomer unit, in particular N-(p-aminosulfonylphenyl)methacrylamide, (2) acrylonitrile and/or methacrylonitrile and (3) methylmethacrylate and/or methylacrylate. Some of these copolymers are available from Kokusan Chemical, Gumma, Japan, under the name PU-Copolymers.

Furthermore, polyacrylates comprising structural units of the following formulas (IIa) and/or (IIb) can be used in the first coating solution:
—[CH₂—CH(CO—X¹—R¹—SO₂NH—R²)]— (IIa)
—[CH₂—CH(CO—X¹—R¹—NHSO₂—R)]— (IIb)
wherein
X¹ represents O or NR³;
R¹ represents a substituted or unsubstituted alkylene group (preferably C₁-C₁₂), cycloalkylene group (preferably C₆-C₁₂), arylene group (preferably C₆-C₁₂) or aralkylene group (preferably C₇-C₁₄);
R² and R³ each independently represent a hydrogen atom or a substituted or unsubstituted alkyl group (preferably C₁-C₁₂); cycloalkyl group (preferably C₆-C₁₂), aryl group (preferably C₆-C₁₂) or aralkyl group (preferably C₇-C₁₄); and
R^{2a} represents a substituted or unsubstituted alkyl group (preferably C₁-C₁₂), cycloalkyl group (preferably C₆-C₁₂), aryl group (preferably C₆-C₁₂) or aralkyl group (preferably C₇-C₁₄).

Such polyacrylates and starting monomers and comonomers for their production are described in detail in EP-A-0 544 264 (pages 3 to 5).

Polymethacrylates analogous to the polyacrylates of the formulas (IIa) and (IIb) can also be used in the first coating solution according to the present invention.

Polyacrylates with sulfonamide pendant groups which additionally comprise a urea group in the side chain can be used as polymer A of the first coating solution as well. Such polyacrylates are for example described in EP-A-0 737 896 and exhibit the following structural unit (IIc): 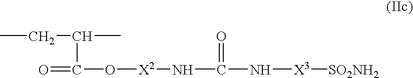
wherein
X² is a substituted or unsubstituted alkylene group (preferably C₁-C₁₂), cycloalkylene group (preferably C₆-C₁₂), arylene group (preferably C₆-C₁₂) or aralkylene group (preferably C₇-C₁₄), and
X³ is a substituted or unsubstituted arylene group (preferably C₆-C₁₂).

Polymethacrylates analogous to the polyacrylates of formula (IIc) can also be used in the first coating solution according to the present invention.

The polyacrylates of formula (IId) with urea groups and phenolic OH mentioned in EP-A-0 737 896 can also be used as polymer A: 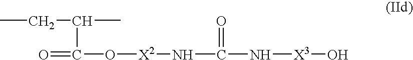
wherein
X² and X³ are as defined above.

Polymethacrylates analogous to the polyacrylates of formula (IId) can also be used in the first coating solution according to the present invention.

The weight average molecular weight of suitable poly(meth)acrylates with sulfonamide pendant groups and/or phenolic pendant groups is preferably 2,000 to 300,000.

Of course, mixtures of different polymers A soluble in alkaline developer can be used as well.

Based on the solids content of the first coating solution, the polymer A soluble in aqueous alkaline developer is present in an amount of at least 50 wt.-%, preferably at least 60 wt.-%, more preferred at least 70 wt.-% and most preferred at least 80 wt.-%. Usually, the amount does not exceed 99.9 wt.-%, more preferably 95 wt.-%, most preferred 85 wt.-%.

The first coating solution furthermore comprises at least one photothermal conversion material (in the following also referred to as “IR absorber”).

The photothermal conversion material is capable of absorbing IR radiation and converting it into heat. The chemical structure of the IR absorber is not particularly restricted, as long as it is capable of converting the radiation it absorbed into heat. It is preferred that the IR absorber show essential absorption in the range of 650 to 1,300 nm, preferably 750 to 1,120 nm, and it preferably shows an absorption maximum in that range. IR absorbers showing an absorption maximum in the range of 800 to 1,100 nm are especially preferred. It is furthermore preferred that the IR absorber does not or does not essentially absorb radiation in the UV range. The absorbers are for example selected from carbon black, phthalocyanine pigments/dyes and pigments/dyes of the polythiophene-squarylium, thiazoluim-croconate, merocyanine, cyanine, indolizine, pyrylium or metaldithiolin classes, especially preferred from the cyanine class. The compounds mentioned in Table 1 of U.S. Pat. No. 6,326,122 for example are suitable IR absorbers. Further examples can be found in U.S. Pat. No. 4,327,169, U.S. Pat. No. 4,756,993, U.S. Pat. No. 5,156,938, WO 00/29214, U.S. Pat. No. 6,410,207 and EP-A-1 176 007.

According to one embodiment, a cyanine dye of the formula (III) 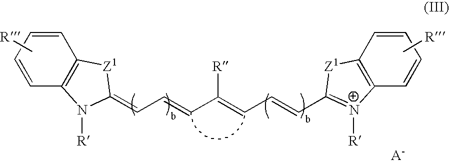
is used, wherein
each Z¹ independently represents S, O, NR^{a} or C(alkyl)₂;
   each R′ independently represents an alkyl group, an alkylsulfonate group or an alkylammonium group;
R″ represents a halogen atom, SR^{a}, OR^{a}, SO₂R^{a} or NR^{a}₂;
each R′″ independently represents a hydrogen atom, an alkyl group, —COOR^{a}, —OR^{a}, —SR^{a}, —NR^{a}₂ or a halogen atom; R′″ can also be a benzofused ring;
A⁻ represents an anion; —
--- represents an optionally present carbocyclic five- or six-membered ring;
R^{a} represents a hydrogen atom, an alkyl or aryl group;
each b can independently be 0, 1, 2 or 3.

If R′ represents an alkylsulfonate group, an inner salt can form so that no anion A⁻ is necessary. If R′ represents an alkylammonium group, a second counterion is needed which is the same as or different from A⁻.
Z¹ is preferably a C(alkyl)₂ group.
R′ is preferably an alkyl group with 1 to 4 carbon atoms.
R″ is preferably a halogen atom or SR^{a}.
R′″ is preferably a hydrogen atom.
R^{a} is preferably an optionally substituted phenyl group or an optionally substituted heteroaromatic group.

The dotted line preferably represents the residue of a ring with 5 or 6 carbon atoms. The counterion A⁻ is preferably a chloride ion, trifluoromethylsulfonate or a tosylate anion.

Of the IR dyes of formula (II), dyes with a symmetrical structure are especially preferred. Examples of especially preferred dyes include:
2-[2-[2-Phenylsulfonyl-3-[2-(1,3-dihydro-1,3,3-trimethyl-2H-indole-2-ylidene)-ethylidene]-1-cyclohexene-1-yl]-ethenyl]-1,3,3-trimethyl-3H-indoliumchloride,
2-[2-[2-thiophenyl-3-[2-(1,3-dihydro-1,3,3-trimethyl-2H-indole-2-ylidene)-ethylidene]-1-cyclohexene-1-yl]-ethenyl]-1,3,3-trimethyl-3H-indoliumchloride,
2-[2-[2-thiophenyl-3-[2-(1,3-dihydro-1,3,3-trimethyl-2H-indole-2-ylidene)-ethylidene]-1-cyclopentene-1-yl]-ethenyl]-1,3,3-trimethyl-3H-indoliumtosylate,
2-[2-[2-chloro-3-[2-(1,3-dihydro-1,3,3-trimethyl-2H-benzo[e]-indole-2-ylidene)-ethylidene]-1-cyclohexene-1-yl]-ethenyl]-1,3,3-trimethyl-1H-benzo[e]-indolium-tosylate and
2-[2-[2-chloro-3-[2-ethyl-(3H-benzthiazol-2-ylidene)-ethylidene]-1-cyclohexene-1-yl]-ethenyl]-3-ethyl-benzthiazolium-tosylate.

The following compounds are also IR absorbers suitable for use in the present invention:

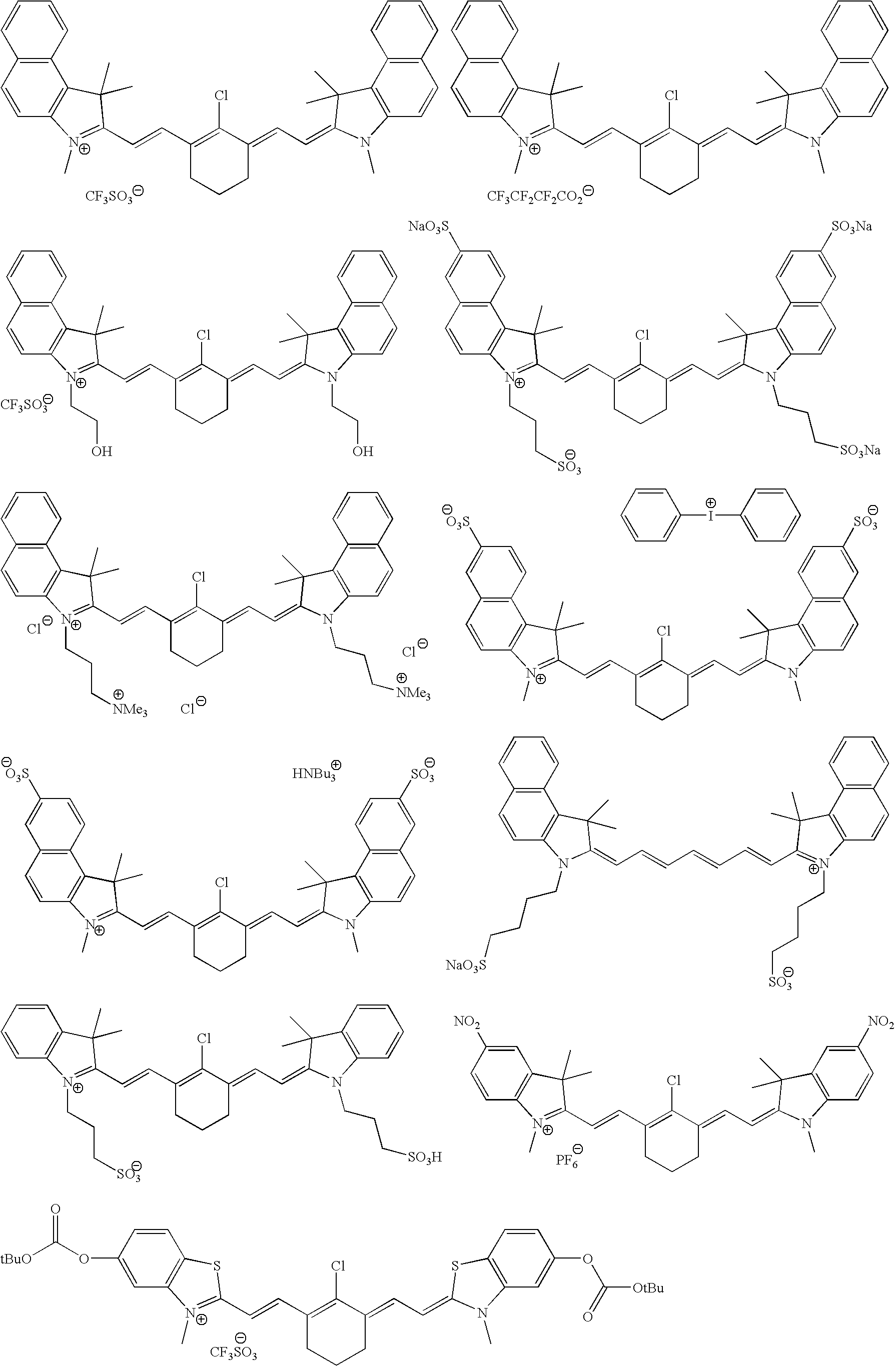

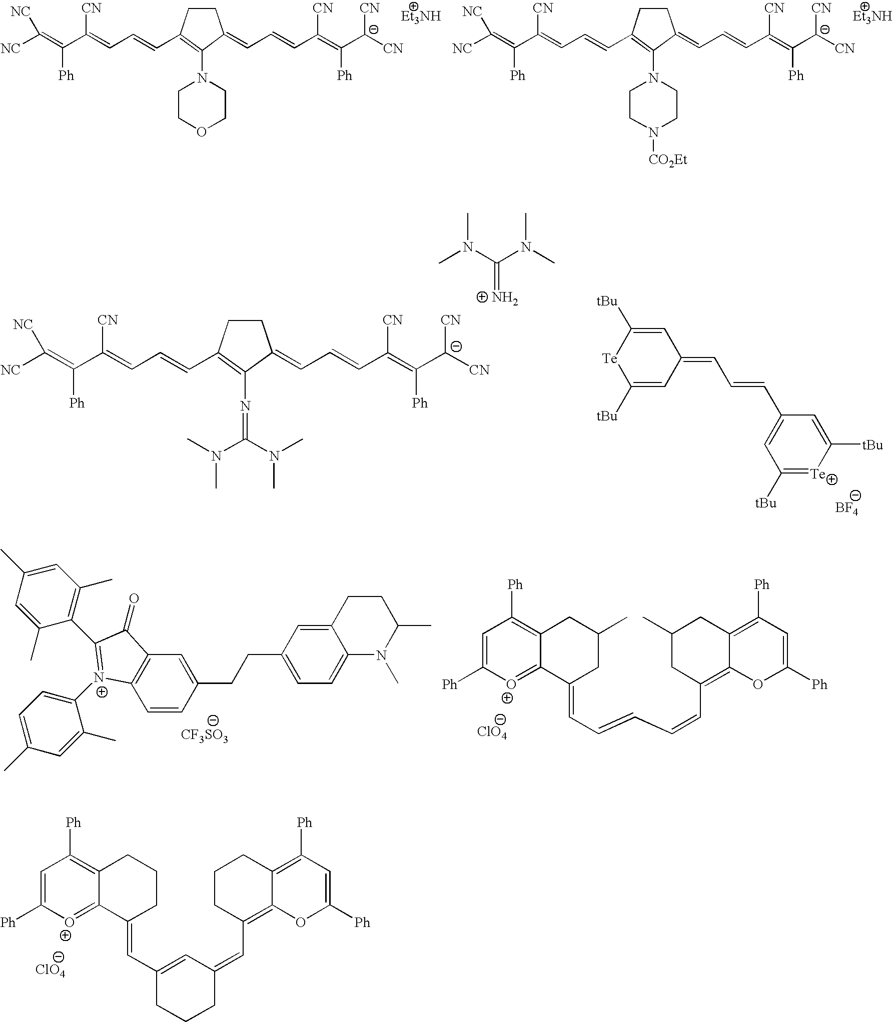

The IR absorber is preferably present in the first coating solution in an amount of at least 0.1 wt.-%, based on the solids content of the coating solution, more preferred at least 1 wt.-%, still more preferred at least 1.5 wt.-%. Usually, the amount of IR absorber does not exceed 50 wt.-%, more preferred 30 wt.-% and most preferred 20 wt.-%. If carbon black is used as IR absorber, it is preferably used in an amount of no less than 40 wt.-%. A single IR absorber or a mixture of two or more can be present; in the latter case, the amounts given refer to the total amount of all IR absorbers.

The first coating solution can furthermore comprise dyes or pigments having a high absorption in the visible spectral range in order to increase the contrast (“contrast dyes and pigments”). Particularly suitable dyes and pigments are those that dissolve well in the solvent or solvent mixture used for coating or are easily introduced in the disperse form of a pigment. Suitable contrast dyes include inter alia rhodamine dyes, triarylmethane dyes such as Victoria blue R and Victoria blue BO, crystal violet and methyl violet, anthraquinone pigments, azo pigments and phthalocyanine dyes and/or pigments. The dyes are preferably present in the first coating solution in an amount of from 0 to 15 wt.-%, more preferred 0.5 to 10 wt.-%, especially preferred in an amount of from 1.5 to 7 wt.-%, based on the solids content of the first coating solution.

Furthermore, the first coating solution can comprise surfactants (e.g. anionic, cationic, amphoteric or non-ionic tensides or mixtures thereof). Suitable examples include fluorine-containing polymers, polymers with ethylene oxide and/or propylene oxide groups, sorbitol-tri-stearate and alkyl-di-(aminoethyl)-glycines. They are preferably present in an amount of 0 to 10 wt.-%, based on the solids content of the first coating solution, especially preferred 0.2 to 5 wt.-%.

The first coating solution can furthermore comprise print-out dyes such as crystal violet lactone or photochromic dyes (e.g. spiropyrans etc.). They are preferably present in an amount of 0 to 15 wt.-%, based on the solids content of the first coating solution, especially preferred 0.5 to 5 wt.-%.

Also, flow improvers can be present in the first coating solution, such as poly(glycol)ether-modified siloxanes; they are preferably present in an amount of 0 to 1 wt.-%, based on the solids content of the first coating solution.

The first coating solution can furthermore comprise anti-oxidants such as e.g. mercapto compounds (2-mercaptobenzimidazole, 2-mercaptobenzthiazole, 2-mercaptobenzoxazole and 3-mercapto-1,2,4-triazole), and triphenylphosphate. They are preferably used in an amount of 0 to 15 wt.-%, based on the solids content of the first coating solution, especially preferred 0.5 to 5 wt.-%.

Other coating additives can of course be present as well.

If the first coating solution comprises a novolak resin as optional component, it is preferably present in an amount of no more than 10 wt.-%, based on the solids content of the first coating solution; it is especially preferred that the first coating solution does not comprise a novolak resin.

The second coating solution comprises at least one polymer B comprising hydroxy groups and/or carboxy groups. The polymer B is different from the polymer A; contrary to polymer B, polymer A is not soluble in the solvent of the second layer.

Novolaks are not suitable as polymer A; they may only be present in the first layer as an optional component in an amount of no more than 10 wt.-%. However, novolaks are suitable as polymer B for the second layer. Novolak resins suitable as polymer B for the second coating solution of the present invention are condensation products of one or more suitable phenols, e.g. phenol itself, m-cresol, o-cresol, p-cresol, 2,5-xylenol, 3,5-xylenol, resorcinol, pyrogallol, phenylphenol, diphenols (e.g. bisphenol-A), trisphenol, 1-naphthol and 2-naphthol with one or more suitable aldehydes such as formaldehyde, acetaldehyde, propionaldehyde, benzaldehyde and furfuraldehyde and/or ketones such as e.g. acetone, methyl ethyl ketone and methyl isobutyl ketone. The type of catalyst and the molar ratio of the reactants determine the molecular structure and thus the physical properties of the resin. Phenylphenol, xylenols resorcinol and pyrogallol are preferably not used as single phenol for the condensation but rather in admixture with other phenols. An aldehyde/phenol ratio of about 0.5:1 to 1:1, preferably 0.5:1 to 0.8:1, and an acid catalyst are used in order to produce those phenolic resins known as “novolaks” and having a thermoplastic character. As used in the present application, however, the term “novolak soluble in aqueous alkaline developer” is also intended to encompass the phenolic resins known as “resols” which are obtained at higher aldehyde/phenol ratios and in the presence of alkaline catalysts as long as they are soluble in aqueous alkaline developers; however, resols are not preferred.

Suitable novolaks can be prepared according to known processes or are commercially available. Preferably, the molecular weight (weight average determined by means of gel permeation chromatography using polystyrene as standard) is between 1,000 and 15,000, especially preferred between 1,500 and 10,000.

Polymers suitable as polymer B for the second coating solution also include polyvinyl phenol resins, i.e. polymers of one or more hydroxystyrenes such as o-hydroxystyrene, m-hydroxystyrene, p-hydroxystyrene, 2-(o-hydroxyphenyl)propylene, 2-(m-hydroxy-phenyl)propylene and 2-(p-hydroxyphenyl)propylene. Such a hydroxystyrene can optionally comprise one or more additional substituents at the phenyl ring, such as e.g. a halogen atom (F, Cl, Br, I). It is important that the polyvinyl phenol resin is soluble in aqueous alkaline developers and comprises free hydroxy groups and/or carboxy groups.

Polyvinyl phenol resins can be produced according to known processes. Usually, one or more hydroxystyrenes are polymerized in the presence of an initiator for free-radical or cationic polymerization.

The weight-average molecular weight of suitable polyvinyl phenol resins is preferably in the range of 1,000 to 100,000, more preferably 1,500 to 50,000.

The polymer B used in the second coating solution can also be selected from acidic polyvinyl acetals, e.g. from polyvinyl acetals comprising the following structural units A, B, C and D: 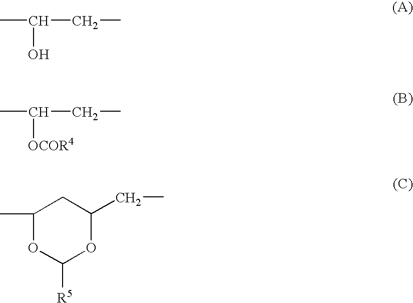
wherein D is at least one unit selected from D-1, D-2 and D-3: 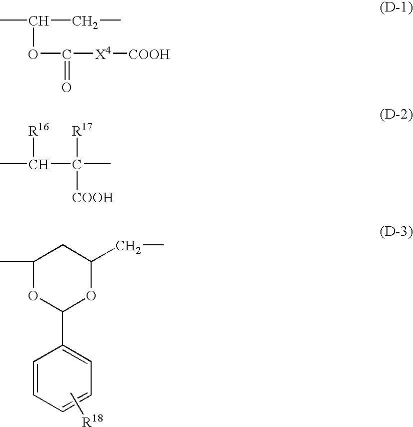
wherein
R⁴ represents H or C₁-C₄ alkyl (preferably H, —CH₃, —CH₂CH₃, especially preferred —CH₃),
R⁵ represents H or C₁-C₁₈ alkyl (preferably —CH₃, —CH₂CH₃, —(CH₂)₂CH₃, especially preferred —CH₂CH₃),
R¹⁶ represents H or C₁-C₄ alkyl (preferably H, —CH₃, —CH₂CH₃, especially preferred H),
R¹⁷ represents H or C₁-C₄ alkyl (preferably H, —CH₃, —CH₂CH₃, especially preferred H),
R¹⁸ represents —COOH, —(CH₂)ₐ—COOH, —O—(CH₂)ₐ—COOH, —SO₃H, —PO₃H₂ or —PO₄H₂ (preferably —COOH, —SO₃H, —PO₃H₂, especially preferred —COOH), and
a is an integer from 1 to 8 (preferably 1 to 4, especially preferred 1).
X⁴ is selected from
—(CR⁶R⁷)ₖ— and —CR⁸═CR⁹—
wherein
k is an integer from 1 to 6,
each R⁶ and R⁷ is independently selected from a hydrogen atom and C₁-C₆ (preferably C₁-C₄) alkyl (if k>1, not all groups R⁶ have to be the same, nor do all groups R⁷ have to be the same), and
R⁸ and R⁹ are independently selected from a hydrogen atom and C₁-C₆ (preferably C₁-C₄) alkyl or R⁸ and R⁹, together with the two carbon atoms to which they are bonded, form an optionally substituted aryl or heteroaryl group. (The optionally substituted aryl group can for example be an optionally substituted phenyl or naphthyl group, with an unsubstituted phenyl group being preferred. The optionally substituted heteroaryl group usually comprises 5 or 6 ring atoms, of which one or more (preferably 1 or 2) are heteroatoms selected from sulfur, oxygen and nitrogen atoms. Preferred heteroaryl groups comprise one oxygen atom, one sulfur atom or one to two nitrogen atoms. Suitable substituents for the aryl and heteroaryl groups are C₁-C₄ alkyl, C₁-C₄ haloalkyl, cyano groups, C₁-C₄ alkoxy and —COOH. The number of substituents—if present—is usually 1 to 3; however, unsubstituted aryl and heteroaryl groups are preferred.)

It is especially preferred that X⁴ be selected from: 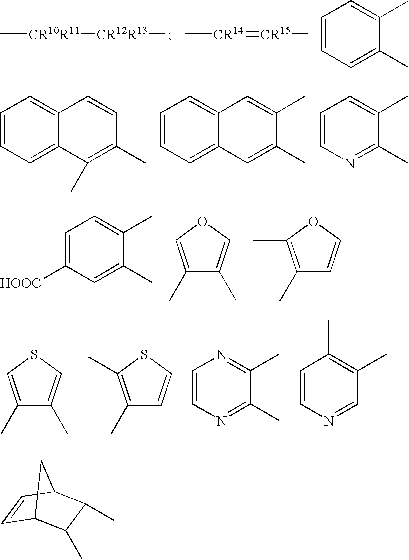
wherein R¹⁰ to R¹⁵ are each independently selected from a hydrogen atom and a C₁-C₆ alkyl group.

It is preferred that the polyvinyl acetals used in the present invention have an acid number of at least 10 mg KOH/g polymer, especially preferred at least 70 mg KOH/g polymer. Preferably, the acid number is not higher than 150 KOH/g polymer, more preferred not higher than 100 KOH/g polymer. The “acid number” indicates the number of mg of KOH necessary for neutralizing 1 g of polymer.

Polyvinyl acetals comprising several different units B and/or C and/or D can also be used in the present invention. The ratio of units A, B, C and D in the polyvinyl acetals of the present invention is not particularly restricted; however, they are preferably present in the following amounts:

Unit A 10 to 40 wt.-% (especially preferred 15 to 30 wt.-%),

unit B 0.1 to 25 wt.-% (especially preferred 1 to 15 wt.-%),

unit C 10 to 80 wt.-% (especially preferred 25 to 65 wt.-%) and

unit D 1 to 40 wt.-% (especially preferred 10 to 20 wt.-%),

each based on the total weight of the acetal polymer.

If several different units B are present, the amount given refers to the total number of units B. The same applies to units C and D.

The vinyl alcohol/vinyl acetate copolymers that serve as starting materials in the preparation of the acidic polyacetals of the present invention are preferably hydrolyzed to a degree of 70 to 98 mole-% and usually have a weight-average molecular weight M_{w} of 20,000 to 130,000 g/mole. Exactly which copolymer is used as a starting material for the synthesis depends on the desired future application of the heat-sensitive element. For offset printing plates, polymers with a weight-average molecular weight M_{w} of 35,000 to 130,000 g/mole and a degree of hydrolysis of the vinyl acetate structural unit of 80 to 98 mole-% are preferably used.

The acidic polyvinyl acetals can be prepared using known methods. Acidic polyvinyl acetals suitable for the present invention and their preparation are described in detail e.g. in U.S. Pat. No. 5,169,897, DE-B-34 04 366 and DE-A-100 11 096.

(Meth)acrylic acid polymers and copolymers, e.g. (meth)acrylic acid ester/(meth)acrylic acid copolymers, are suitable as polymer B, in particular those with acid numbers of about 50 to 100. In this connection, the copolymer groups with the trade name “Carboset”, commercially available from Goodrich, should be mentioned.

The polymer B is preferably present in the second coating solution an in amount of 30 to 98 wt.-%, based on the solids content of the second coating solution, especially preferred 40 to 85 wt.-%.

Furthermore, the second coating solution comprises one or more polyfunctional enolethers. These enolethers have to comprise at least two enolether groups. It is preferred that the boiling point of the enolethers is not below 70° C. under normal atmospheric pressure since otherwise they may evaporate during drying.

A variety of polyfunctional enolethers meeting the above-mentioned requirements is known and commercially available. Numerous examples are for instance described in U.S. Pat. No. 5,658,708 A.

In particular, the following should be mentioned:

Isophthalic acid dibutylene vinyl ether, ethylene glycol divinyl ether, triethylene glycol divinyl ether, 1,3-butanediol divinyl ether, tetramethylene glycol divinyl ether, neopentyl glycol divinyl ether, trimethylol propane trivinyl ether, trimethylol ethane trivinyl ether, hexanediol divinyl ether, 1,4-cyclohexanediol divinyl ether, tetraethylene glycol divinyl ether, pentaerythritol divinyl ether, pentaerythritol trivinyl ether, pentaerythritol tetravinyl ether, sorbitol tetravinyl ether, sorbitol pentavinyl ether, ethylene glycol diethylene vinyl ether, triethylene glycol diethylene vinyl ether, ethylene glycol dipropylene vinyl ether, triethylene glycol diethylene vinylether, trimethylolpropane triethylene vinyl ether, trimethylolpropane diethylene vinyl ether, pentaerythritol diethylene vinyl ether, pentaerythritol triethylene vinyl ether, pentaerythritol tetraethylene vinyl ether, 1,2-di(vinyl ether methoxy)benzene, 1,2-di(vinyl ether ethoxy)benzene, terephthalic acid diethylene vinyl ether, phthalic acid diethylene vinyl ether, isophthalic acid diethylene vinyl ether, phthalic acid dipropylene vinyl ether, terephthalic acid dipropylene vinyl ether, isophthalic acid dipropylene vinyl ether, maleic acid diethylene vinyl ether, fumaric acid diethylene vinyl ether, itaconic acid diethylene vinyl ether, adipic acid dibutylene vinyl ether, succinic acid dibutylene vinyl ether, bis[4-(vinyloxymethyl)cyclohexylmethyl]glutarate, tris[4-(vinyloxy)butyl]trimellitate, bis[4-(vinyloxy)butyl]hexandiylbiscarbamate, bis[[4-[(vinyloxy)methyl]cyclohexyl]methyl]terephthalate, bis[[4-[(vinyloxy)methyl]cyclohexyl]methyl]isophthalate, bis[4-(vinyloxy)butyl](4-methyl-1,3-phenylene)biscarbamate, bis[4-(vinyloxy)butyl](methylene-di-4,1-phenylene)biscarbamate.

Bisvinyl ethers of isophthalic acid are preferred; of those, bis[4-(vinyloxy)butyl]isophthalate is especially preferred.

The polyfunctional enolether is preferably present in an amount of at least 2 wt.-% and less than 70 wt.-%, based on the solids content of the second coating solution, more preferred 10 to 60 wt.-%, still more preferred 20 to 40 wt.-%.

No IR absorber is present in the second coating solution.

Additionally, the second coating solution can comprise dyes or pigments having a high absorption in the visible spectral range. Suitable dyes and pigments include e.g. those described above in connection with the first coating solution. The colorants are preferably present in an amount of 0 to 5 wt.-%, more preferred 0.5 to 3 wt.-%, based on the solids content of the second coating solution.

The surfactants mentioned in connection with the first coating solution can also be present in the second coating solution. Here, they are preferably present in an amount of 0 to 2 wt.-%, more preferred 0 to 0.5 wt.-%, based on the solids content of the second coating solution.

The second coating solution can also comprise acid generators which release acids upon being heated. Examples include diazonium, iodonium, sulfonium, phosphonium, ammonium, oxysulfoxonium, oxysulfonium and sulfoxonium salts with non-nucleophilic anions such as tetrafluoroborate, hexafluorophosphate, hexafluoroarsenate, hexafluoroantimonate, triflate, tetrakis(pentafluorophenyl)borate, pentafluoroethylsulfonate, p-methylbenzylsulfonate, ethylsulfonate, trifluoromethylacetate and pentafluoroethylacetate anions. However, C₁-C₅ alkylsulfonates, arylsulfonates, N—C₁-C₅-alkylsulfonylsulfonamides such as e.g. benzoin tosylate, 2-hydroxymethylbenzoin tosylate and N-methanesulfonyl-2,4-dimethylbenzene sulfonamide and combinations of two or more of the above can be used as well. They are preferably present in an amount of 0 to 25 wt.-%, especially preferred 0 to 10 wt.-%, particularly preferred 0 to 5 wt.-%, based on the solids content of the second coating solution. According to a preferred embodiment, no acid generator is present.

Furthermore, the second coating solution can comprise flow control agents such as poly(glycol)ether-modified starch. They are preferably present in an amount of 0 to 1 wt.-%, based on the solids content of the coating solution.

The selection of the solvent (mixtures) for the first and second coating solutions depends on which polymers A and B have been chosen. In order to prevent the first layer from dissolving upon application of the second layer and thus a mixing of the two layers, a solvent (mixture) should be selected for the second coating solution wherein polymer B and the polyfunctional enolether dissolve sufficiently and wherein polymer A is essentially insoluble.

Usually, the polymers A are soluble in polar solvents and insoluble in only slightly polar solvents. Suitable solvents are e.g. protic, water-soluble solvents, in particular ethylene glycol monomethyl ether, methyl lactate, methanol and mixtures thereof; these solvents can also be combined with 1,3-dioxolane, ketones, such as acetone and methyl ethyl ketone, and mixtures thereof.

Since the polymers A are usually soluble in polar solvents, a solvent (mixture) with a low degree of polarity should be used for the second coating solution, such as e.g. butylacetate, methyl ethyl ketone, toluene, diethylketone, Dowanol PM, Dowanol PMA, methyl isobutyl ketone and mixtures thereof.

Commonly used coating devices can be used for applying the coating solutions; the coating solutions can for example be applied by means of spin coating, coating with doctor blades, roll coating, gravure coating, or coating with a slot nozzle (also referred to slot coater, Hopper coater).

It is important that after the application of the first coating solution, the first layer be allowed to dry until there is no more tackiness in order to substantially prevent a mixing of the two layers. The drying temperature is usually in the range of 60 to 140° C. The required drying time depends on several factors, such as layer thickness, drying temperature, the solvent (mixture) that was used and the solids content of the coating solution; most of the time it is in the range of 2 to 300 seconds.

After application of the second coating solution, drying has to take place at a temperature of at least 60° C. in order to achieve insolubility of the unexposed layer in aqueous alkaline developers. Preferably, drying is carried out at 60 to 150° C., especially preferred at 90 to 120° C. In this case as well, the drying time depends on various factors, such as layer thickness, solvent and solids content of the coating solution; most of the time it is in the range of 2 to 300 seconds.

The dry layer weight of the first layer is preferably 0.1 to 5 g/m², more preferred 0.5 to 1.5 g/m².

The dry layer weight of the second layer (layer comprising enolether) is preferably 0.1 to 5 g/m², more preferred 1 to 3 g/m².

The imageable elements produced according to the present invention can be imaged with IR radiation. Semiconductor lasers or laser diodes which emit in the range of 650 to 1,300 nm, preferably 750 to 1,120 nm, can for example used as a radiation source. The laser radiation can be digitally controlled via a computer, i.e. it can be turned on or off so that an image-wise exposure of the plates can be effected via stored digitalized information in the computer; thus, so-called computer-to-plate (ctp) printing plates can be obtained. All image-setters with IR lasers known to the person skilled in the art can be used for this purpose.

The image-wise irradiated/heated elements such as printing plate precursors are developed with an aqueous alkaline developer, which usually has a pH value in the range of 10 to 14. For this purpose, commercially available developers can be used.

The developed printing plates can additionally be subjected to a “baking” step in order to increase the abrasion resistance of the printing areas; however, this is not necessarily required for the printing plates of the present invention since even without baling high numbers of copies can be printed without any loss in quality.

Preferably, the heat-sensitive elements produced according to the present invention are not sensitive to visible light and the UV portion of daylight under common processing conditions for printing plates so that they can be processed under white light, i.e. they do not require yellow light conditions.

The invention will be explained in more detail in the following examples; however, they shall not restrict the invention in any way.

### EXAMPLES

### Example 1

An electrochemically grained, anodized aluminum foil provided with a layer of polyvinyl phosphonic acid was used as a substrate.

The following coating solution was applied to the pretreated substrate by means of a wire-wound doctor:
4.8 g of a copolymer of N-phenylmaleimide, methacrylamide and methacrylic acid (molar ratio 45:35:20),
0.72 g Trump dye (IR absorber with an absorption maximum at 830 nm), 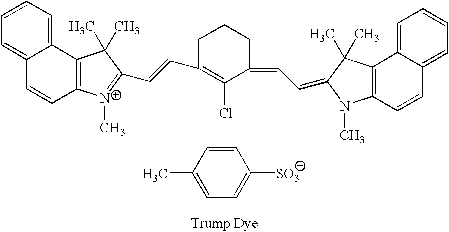
45 g of a solvent mixture of methyl lactate, methanol and dioxolane (weight ratio: 42.5:15:42.5).

After drying for 2 minutes at 100° C., a layer with a dry layer weight of 2.0 g/m² was obtained.

A second coating solution was prepared and applied onto the first layer also by means of a wire-wound doctor. The second coating solution consisted of a 10 wt.-% solution of

67 parts by weight PD 140 A (m/p-cresol novolak from Borden Chemicals) and

33 parts by weight VEctomer 4010 (bis[4-(vinyloxy)butyl]isophthalate from Allied Signal)

in a solvent mixture of Dowanol PMA and isopropanol (weight ratio 1:4).

After drying for 1 minute in a warm air stream, an overcoat layer with a dry layer weight of 1.4 g/m² was obtained.

Then the printing plate precursor was heated in a 100° C. oven for 10 minutes.

The printing plate precursor was then image-wise exposed with a Creo Trendsetter (laser diode with a wavelength of 830 nm) and subsequently developed with Goldstar developer at 25° C. for 30 seconds.

The photospeed was 150 mJ/cm². The printing plate showed good resolution (2×2 pixel elements had been reproduced well). Printing with a sheet-fed offset printing machine provided 130,000 copies of good quality.

### Comparative Example 1

Example 1 was repeated, however, no Vectomer 4010 was added to the second coating solution but only 100 parts by weight of PD 140 A were used.

After developing with Goldstar developer, no coating remained on the substrate.

### Comparative Example 2

Example 1 was repeated, but the second coating solution only contained novolak (and no bisvinyl ether). Exposure and developing was carried out as described in Example 1. Printing only yielded about 70,000 copies since at that point the plate already showed clear signs of wear.

### Comparative Example 3

Example 1 was repeated, but the second coating solution consisted of a 10 wt.-% solution of

63 parts by weight PD 140A

29 parts by weight Vectomer 4010 and

8 parts by weight TrampDye

in a solvent mixture of Dowanol PMA and isopropanol (weight ratio 1:4).

After imagewise exposure the precursor was treated with Goldstar developer, however, neither the exposed nor the unexposed areas of the layers could be removed, i.e. no image was obtained.

1. A process for the production of a heat-sensitive imageable element comprising:
(a) applying a first coating solution to a substrate,
the first coating solution comprising at least one photothermal conversion material, at least one polymer A soluble or swellable in an aqueous alkaline developer and at least one solvent,
(b) drying the applied first coating solution,
(c) applying a second coating solution to the applied first coating solution,
the second coating solution comprising at least one cross-linkable polyfunctional enolether, at least one polymer B comprising hydroxy groups and/or carboxy groups, and at least one solvent, wherein the polymer A used in the first coating solution does not dissolve in the second coating solvent,
wherein the second coating solution does not contain a photothermal conversion material, and
(d) heating to a temperature of at least 60° C.

2. The process according to claim 1 wherein the polymer A of the first coating solution is selected from copolymers derived from N-substituted maleimides and comonomers copolymerizable therewith, copolymers comprising a urea group in the side chain, and copolymers with a sulfonamide group in the side chain, and mixtures thereof.

3. The process of claim 1 wherein the polymer B of the second coating solution is selected from novolaks, polyvinyl phenolic resins, acidic polyvinyl acetals and (meth)acrylic acid ester/(meth)acrylic acid copolymers, and mixtures thereof.

4. The process of claim 1 wherein the photothermal conversion material has the formula 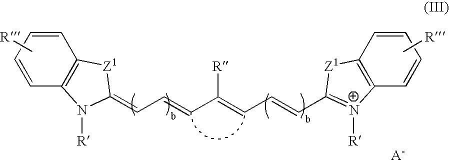
wherein
each Z¹ independently represents S, O, NR^{a} or C(alkyl)₂;
each R′ independently represents an alkyl group, an alkylsulfonate group or an alkylammonium group;
R″ represents a halogen atom, SR^{a}, OR^{a}, SO₂R^{a} or NR^{a}₂;
each R′″ independently represents a hydrogen atom, an alkyl group, —COOR^{a}, —OR^{a},
—SR^{a}, —NR^{a}₂ or a halogen atom; R′″ can also be a benzofused ring;
A⁻ represents an anion;
--- represents an optionally present carbocyclic five- or six-membered ring;
R^{a} represents a hydrogen atom, an alkyl or aryl group;
each b can independently be 0, 1, 2 or 3.

5. The process of claim 1 wherein the polyfunctional enolether is bis[4-(vinyloxy)butyl]isophthalate.

6. The process of claim 1 wherein the first coating solution further comprises at least one additive selected from contrast dyes and pigments, surfactants, print-out dyes, flow control agents, and antioxidants.

7. The process of claim 1 wherein the second coating solution furthermore comprises at least one additive selected from contrast dyes and pigments, surfactants, print-out dyes, flow control agents, and antioxidants.

8. The process of claim 1 wherein the solvent for the first coating solution comprises methyl lactate.

9. The process of claim 1 wherein the solvent for the second coating solution comprises propylene glycol monomethylether acetate.

10. The process of claim 1 wherein the application of the coating solutions in steps (a) and (c) is carried out by means of a slot coater.

11. The process of claim 1 wherein the drying of step (d) is carried out at a temperature in the range of 60 to 150° C.

12. The process of claim 1 wherein prior to the application of the first coating solution, the substrate is subjected to at least one treatment selected from graining, anodizing and hydrophilizing.

13. The process of claim 1 wherein the substrate is an aluminum plate or foil.

14. A heat-sensitive imageable element obtained by the process of claim 1.

15. A precursor of a heat-sensitive imageable element comprising:
(a) a substrate,
(b) a first layer on the substrate
comprising at least one photothermal conversion material and at least on polymer A soluble or swellable in an aqueous alkaline developer, and
(c) a second layer
comprising at least one cross-linkable polyfunctional enolether and at least one polymer B comprising hydroxy groups and/or carboxy groups, wherein the second layer does not contain a photothermal conversion material.

16. A heat-sensitive imageable element obtained by heating the precursor of claim 15 to a temperature of at least 60° C.
